(19) United States
(12) Patent Application Publication
(10) Pub. No.: US 2026/0255464 A1
(43) Pub. Date: Aug. 27, 2026

(54) POWER DISTRIBUTION MANAGEMENT FOR EXTENDED LIGHT FIXTURES

(71) Applicant: SIGNIFY HOLDING B.V., EINDHOVEN (NL)

(72) Inventors: RAYMOND GEORGE JANIK, FAYETTEVILLE, GA (US); NEIL THOMAS HARDWICK, LOUISVILLE, CO (US); RUSSELL SCOTT TRASK, SHARPSBURG, GA (US)

(21) Appl. No.: 19/163,000

(22) PCT Filed: Feb. 21, 2024
(86) PCT No.: PCT/EP2024/054363

§ 371 Date: Sep. 8, 2025

Related U.S. Application Data
(60) Provisional application No. 63/451,313, filed on Mar. 10, 2023.

(30) Foreign Application Priority Data
Apr. 4, 2023 (EP) 23166580.3

(51) Int. Cl. H05B 47/20

(52) U.S. Cl. CPC H05B 47/20

(57) ABSTRACT

A printed circuit board (PCB) assembly for an extended light fixture can include: a PCB having a body; a first and second connector portion positioned proximate to an outer perimeter of the body; multiple electrical conductors coupled to the first and second connector portions, where each of the electrical conductors runs continuously between the first connector portion and the second connector portion; a light source receiving feature disposed on the body, connected to one of the plurality of electrical conductors, and configured to receive a light source; and a switching apparatus in communication with the electrical conductors, where the switching apparatus has a first configuration and a second configuration, where the switching apparatus enables a first subset of the electrical conductors when in the first configuration, and where the switching apparatus enables a second subset of the electrical conductors when in the second configuration.

### TECHNICAL FIELD

The present disclosure relates generally to luminaires, and more particularly to systems, methods, and devices for power distribution management for extended light fixtures.

### BACKGROUND

Linear light fixtures are often installed end-to-end to create a single extended linear luminaire. The light sources of linear light fixtures are mounted on a circuit board. The light sources draw their power from a voltage source (also called a power source herein) that is remote relative to the circuit board, if not the housing in which the circuit board is mounted. The electrical conductor carrying the power to each light source loses some power through line resistance, and each light source uses some amount of power to operate. When too many light sources are fed by a single electrical conductor and/or when the distance of one or more of the light sources from the voltage source becomes too great, the voltage source may not be able to reliably provide power to all of the light sources.

### SUMMARY

In general, in one aspect, the disclosure relates to a printed circuit board assembly for an extended light fixture. The printed circuit board assembly can include a printed circuit board comprising a body. The printed circuit board assembly can also include a first connector portion positioned proximate to an outer perimeter of the body. The printed circuit board assembly can further include a second connector portion positioned proximate to the outer perimeter of the body. The printed circuit board assembly can also include a plurality of electrical conductors coupled to the first connector portion and the second connector portion, where each of the plurality of electrical conductors runs continuously between the first connector portion and the second connector portion. The printed circuit board assembly can further include a light source receiving feature disposed on the body and connected to the plurality of electrical conductors, where the light source receiving feature is configured to receive a light source. The printed circuit board assembly can also include a switching apparatus in communication with the plurality of electrical conductors, where the switching apparatus has a first configuration and a second configuration, wherein the switching apparatus enables a first subset of the plurality of electrical conductors when in the first configuration, where the switching apparatus enables a second subset of the plurality of electrical conductors when in the second configuration, where the light source receiving feature receives electrical flow from the first subset of the plurality of electrical conductors and is bypassed by the second subset of the plurality of electrical conductors when the switching apparatus is in the first configuration, and where the light source receiving feature receives the electrical flow from the second subset of the plurality of electrical conductors and is bypassed by the first subset of the plurality of electrical conductors when the switching apparatus is in the second configuration.

In other aspects, the disclosure relates to an extended light fixture that includes a power source. The extended light fixture can also include an electrical cable having a first end and a second end, where the first end is coupled to the power source. The extended light fixture can further include a printed circuit board (PCB) assembly. The PCB assembly of the extended light fixture can include a PCB having a body. The PCB assembly of the extended light fixture can also include a connector portion positioned proximate to an outer perimeter of the body, where the connector portion is coupled to the second end of the electrical cable. The PCB assembly of the extended light fixture can further include a plurality of electrical conductors coupled to the connector portion, where each of the plurality of electrical conductors runs continuously along the body from the connector portion. The PCB assembly of the extended light fixture can also include a switching apparatus in communication with the plurality of electrical conductors, where the switching apparatus has a first configuration and a second configuration, where the switching apparatus enables a first subset of the plurality of electrical conductors when in the first configuration, and where the switching apparatus enables a second subset of the plurality of electrical conductors when in the second configuration. The PCB assembly of the extended light fixture can further include a light source receiving feature disposed on the body and connected to one of the plurality of electrical conductors. The extended light fixture can also include a light source coupled to the light source receiving feature in the PCB, where the light source operates using electrical flow when the switching apparatus is in the first configuration, and wherein the light source is bypassed when the switching apparatus is in the second configuration.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a schematic diagram of a lighting system that includes an extended light fixture according to certain example embodiments.

FIG. 2 shows a front sectional view of a printed circuit board of an extended light fixture according to certain example embodiments.

FIG. 3 shows various views of a front sectional view of another printed circuit board of an extended light fixture according to certain example embodiments.

FIG. 4 shows a top view of an assembly of an extended light fixture according to certain example embodiments.

FIG. 5 shows a system diagram of an extended light fixture according to certain example embodiments.

FIG. 6 shows a system diagram of another extended light fixture according to certain example embodiments.

FIG. 7 shows a system diagram of yet another extended light fixture according to certain example embodiments.

FIG. 8 shows a system diagram of still another extended light fixture according to certain example embodiments.

FIG. 9 shows a top view of part of a printed circuit board assembly of an extended light fixture according to certain example embodiments.

FIG. 10 shows a system diagram of an extended light fixture according to certain example embodiments.

### DETAILED DESCRIPTION

In general, example embodiments provide systems, methods, and devices for power distribution management for extended light fixtures. Example embodiments can provide a number of benefits. Such benefits can include, but are not limited to, fewer parts to keep in inventory, modularity, ease of installation, increased configurability options, user control, and increased reliability. Example embodiments can be used with new extended light fixtures (more broadly known as luminaires) or retrofit with existing extended light fixtures. Example embodiments can be used with any of a number of types of luminaires. Examples of such types of luminaires can include, but are not limited to, linear light fixtures and light fixtures using flex tape technology. Example embodiments described herein can be used with extended light fixtures having any of a number of lengths (e.g., 6 inches, 12 inches, 24 inches, 10 feet).

Extended light fixtures with example printed circuit boards and other components can be located in one or more of any of a number of environments. Examples of such environments can include, but are not limited to, indoors, outdoors, a parking garage, a kitchen or cooking space, a hallway, an entertainment room, an office space, a manufacturing plant, a warehouse, and a storage facility, any of which can be climate-controlled or non-climate-controlled. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill.

Extended light fixtures with example printed circuit boards and other components can be directly or indirectly mounted onto any of a number of different structures. Such structures can include, but are not limited to, drywall, wood studs, concrete, and ceiling tile. Indirect mounting of extended light fixtures with example printed circuit boards and other components can involve the use of cables, standoffs, conduit, and spacers. A user may be any person that interacts with extended light fixtures. Examples of a user may include, but are not limited to, an engineer, an electrician, an instrumentation and controls technician, an operator, a property manager, a homeowner, a tenant, an employee, a consultant, a contractor, and a manufacturer's representative.

Extended light fixtures with example printed circuit boards and other components (including portions thereof) can be made of one or more of a number of suitable materials to allow the extended light fixtures to meet certain standards and/or regulations while also maintaining durability in light of the one or more conditions under which the extended light fixtures and/or other associated components of the extended light fixtures can be exposed. Examples of such materials can include, but are not limited to, silicone, aluminum, stainless steel, fiberglass, glass, plastic, polymer, ceramic, and rubber.

Example printed circuit boards and other components, or portions thereof, described herein can be made from a single piece (as from a mold, injection mold, die cast, or extrusion process). In addition, or in the alternative, example printed circuit boards and other components (including portions thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more portions of an example printed circuit board and/or other components to become coupled, directly or indirectly, to one or more other components of the extended light fixture and/or to a structure (e.g., a stud, drywall, a beam). A coupling feature can include, but is not limited to, a clamp, a portion of a hinge, an aperture, a recessed area, a protrusion, a hole, a slot, a tab, a detent, and mating threads. One portion of an example printed circuit board and/or other related components can be coupled to a component of the extended light fixture and/or to a structure by the direct use of one or more coupling features.

In addition, or in the alternative, a portion of an example printed circuit board and/or other related components can be coupled to another component of the extended light fixture and/or to a structure using one or more independent devices that interact with one or more coupling features disposed on a printed circuit board and/or other related components. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of printed circuit boards and other components for extended light fixtures, one or more of the components shown may be omitted, repeated, and/or substituted. Accordingly, example embodiments of printed circuit boards and other components for extended light fixtures should not be considered limited to the specific arrangements of components shown in any of the figures. For example, features shown in one or more figures or described with respect to one embodiment can be applied to another embodiment associated with a different figure or description.

In certain example embodiments, extended light fixtures that include example printed circuit boards and other components are subject to meeting certain standards and/or requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to electrical enclosures, wiring, and electrical connections. Use of example embodiments described herein meet (and/or allow the extended light fixtures to meet) such standards when applicable. For example, the NEC maintains standards for Class 2 power sources.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of power distribution management for extended light fixtures will be described more fully hereinafter with reference to the accompanying drawings, in which example embodiments of power distribution management for extended light fixtures are shown. Power distribution management for extended light fixtures may, however, be embodied in many different forms and should not be construed as limited to the example embodiments set forth herein. Rather, these example embodiments are provided so that this disclosure will be thorough and complete, and will fully convey the scope of power distribution management for extended light fixtures to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”. “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of power distribution management for extended light fixtures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

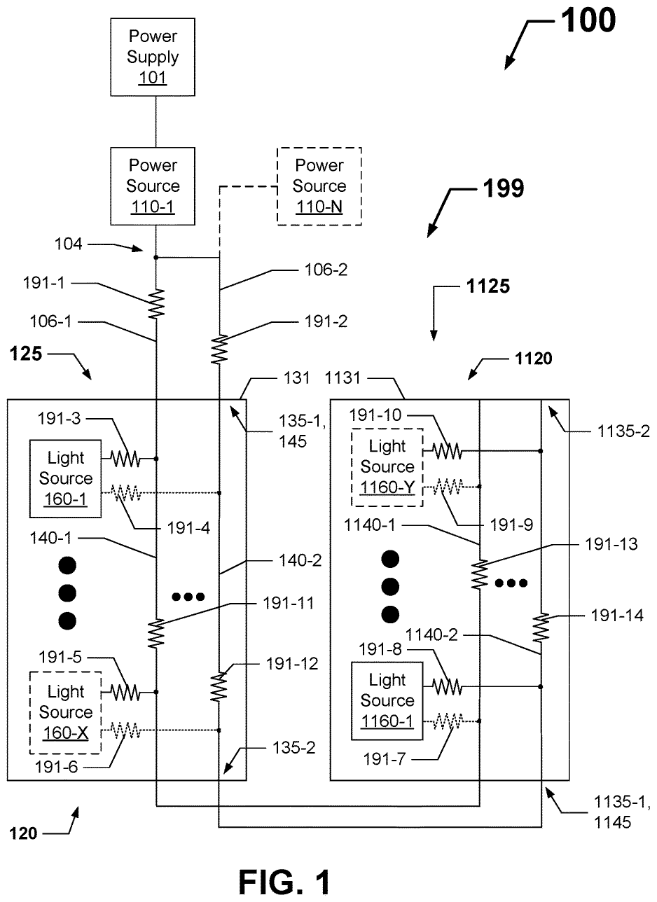

FIG. 1 shows a schematic diagram of a lighting system 100 that includes an extended light fixture 199 according to certain example embodiments. In addition to the extended light fixture 199, the lighting system 100 of FIG. 1 includes a power supply 101.

The extended light fixture 199 includes multiple components. For example, in this case, the extended light fixture 199 includes one or more power sources 110, one or more electrical cables 104, one or more printed circuit board (PCB) assemblies (e.g., PCB assembly 125, PCB assembly 1125). The lighting system 100 can also include one or more electrical cables between the power supply 101 and the one or more power sources 110.

Each PCB assembly can include a PCB and one or more light sources. For example, in this case, PCB assembly 125 includes a PCB 120 and one or more light sources 160 (e.g., light source 160-1 through light source 160-X). As another example, PCB assembly 1125 includes a PCB 1120 and one or more light sources 1160 (e.g., light source 1160-1 through light source 1160-Y). Each PCB of a PCB assembly includes a body, multiple electrical conductors, and one or more light source receiving features. For example, in this case, PCB 120 of PCB assembly 125 includes a body 131 and two electrical conductors 140 (electrical conductor 140-1 and electrical conductor 140-2) that run continuously through the body 131. Similarly, PCB 1120 of PCB assembly 1125 includes a body 1131 and two electrical conductors 1140 (electrical conductor 1140-1 and electrical conductor 1140-2) that run continuously through the body 1131.

The power supply 101 of the lighting system 100 can be any source of power that is used, directly or indirectly, by the extended light fixture 199. The power provided by the power supply 101 to one or more of the power sources 110 can be of a type (e.g., alternating current (AC), direct current (DC)) and level (e.g., 240V, 120V, 24V) that can be received by the power sources 110. In some cases, the power supply 101 can be AC mains. In addition, or in the alternative, the power supply 101 can be or include an electric generator.

The power delivered by the power supply 101 to the power sources 110 can be facilitates by an electrical cable that is substantially similar to the electrical cable 104 discussed below.

Each power source 110 of the extended light fixture 199 is configured to receive power from the power supply 101 and use that power to provide power that is used by one or more of the PCB assemblies (e.g., PCB assembly 125, PCB assembly 1125) of the extended light fixture 199. Specifically, each power source 110 obtains power from the power supply 101 and manipulates (e.g., transforms, rectifies, inverts) that power to provide the manipulated power to one or more of the PCB assemblies, where the manipulated power is of a type (e.g., AC, DC) and level (e.g., 12V, 24V, 120V) that can be used by the PCB assemblies.

Each power source 110 can include one or more of a number of single or multiple discrete components (e.g., transistor, diode, resistor, transformer, inverter, converter, inductor, capacitor) and/or a microprocessor. A power source 110 may include a printed circuit board, upon which one or more microprocessors and/or one or more other discrete components are positioned. In addition, or in the alternative, a power source 110 can be a source of power in itself to provide power and/or signals to the other components of the extended light fixture 199. For example, a power source 110 can be or include an energy storage device (e.g., a battery). As another example, a power source 110 can be or include a localized photovoltaic power system.

The electrical cable 104 includes one or more wires 106 that are configured to facilitate electrical flow (e.g., power, control signals, communication signals) from a power source 110 to the PCB assembly 125. In this case, the electrical cable 104 has two wires 106 (wire 106-1 and wire 106-2). Each wire 106 of the electrical cable 104 has a gauge (e.g., 12 AWG, 20 AWG, 6 AWG) suitable to carry the level of power suitable to operate the PCB assemblies 125, 1125. Each wire 106 can be coated with an electrically non-conductive material (e.g., rubber, nylon), sometimes called an insulating layer, that is removable by a user. In this way, the extreme ends of the wire 106 can be exposed by removing the insulating layer so that the ends of the wire 106 can be directly or indirectly electrically coupled to another component of the system 100.

Each wire 106 of the electrical cable 104 has a line resistance 191, which results in some amount of lost power in an amount proportional to the amount of line resistance 191 as electrical flow from a power source 110 flows through the wire 106. In this case, wire 106-1 has line resistance 191-1, and wire 106-2 has line resistance 191-2. The amount of line resistance 191 (and so the amount of corresponding line loss) in a wire 106 can be based on one or more of a number of factors, including but not limited to the material of the wire 106, the length of the wire 106, the ambient temperature, and the size (gauge) of the wire 106.

As discussed below, the distal end of each wire of the electrical cable 104 is directly or indirectly coupled to a connector portion 135-1 of the PCB assembly 125.

Extending from the connector portion 135-1 of the PCB assembly 125 are the multiple electrical conductors 140 in the PCB 120 of the PCB assembly 125. In this way, the electrical conductors 140 are electrically coupled to the wires 106 of the electrical cable 104. In this example, electrical conductor 140-1 is electrically coupled to wire 106-1, and electrical conductor 140-2 is electrically coupled to wire 106-2. In some cases, a single wire 106 is electrically coupled to a single electrical conductor 140. Alternatively, a single wire 106 is electrically coupled to multiple electrical conductors 140.

Each electrical conductor 140 of the PCB 120 is or includes one or more of a number of electrically-conductive material (e.g., aluminum, copper) that is disposed in a channel of the body 131 of the PCB 120. Such a channel can be within the body 131 (thereby encapsulating the electrical conductor 140) or on an outer surface of the body 131 (thereby allowing part of the electrical conductor 140 to be exposed) of the PCB 120. An electrical conductor 140 can be called a trace in some cases. As discussed below, the distal end of each electrical conductor 140 is electrically coupled to a connector portion 135-2 of the PCB assembly 125. Such a connector portion 135-2 can be configured to couple to another component (e.g., a connector portion of the PCB assembly 1125) of the extended light fixture.

Each electrical conductor 140 has a line resistance 191, which results in some amount of lost power in an amount proportional to the amount of line resistance 191 as electrical flow from a power source 110 flows through the electrical conductor 140. In this case, electrical conductor 140-1 has line resistance 191-11, and electrical conductor 140-2 has line resistance 191-12. The amount of line resistance 191 (and so the amount of corresponding line loss) in an electrical conductor 140 can be based on one or more of a number of factors, including but not limited to the material of the electrical conductor 140, the length of the electrical conductor 140, the ambient temperature, and the size of the electrical conductor 140.

The PCB 120 has one or more light sources 160 coupled thereto. For example, in this case, there can be X light sources 160 (light source 160-1 through light source 160-X) coupled to the PCB 120. Each light source 160 is configured to emit light (e.g., to provide general illumination, to provide accent lighting) into a volume of space (e.g., a room, an office space). A light source 160 can use any of a number of technologies (e.g., light-emitting diode (LED), incandescent, fluorescent, halogen) suitable for use with the extended light fixture 199. A light source 160 can include one or more of a number of components in addition to a light source. Such components can include, but are not limited to, a converter, an inverter, a resistor, a diode, and a capacitor.

Each light source 160 of the PCB assembly 125 illuminates using power (e.g., emergency power, normal operating power) and/or control (e.g., dimming) provided by one of the electrical conductors 140 in the PCB 120. Under such a configuration, each electrical conductor 140 can have one or more legs or branches within the PCB 120. Each leg or branch of an electrical conductor 140 can terminate at a light source 160 coupled to the PCB 120 at a light source receiver (discussed below). In some cases, as in this example, each electrical conductor 140 has a leg or branch for each light source 160. In alternative embodiments, a leg or branch from an electrical conductor 140 can provide power to multiple light sources 160 through the use of sub-branches or similar configurations. In certain example embodiments, each light source 160 of the PCB assembly 125 is configured to be electrically coupled to one or more of the electrical conductors 140. For example, in this case, light source 160-1 is configured to be electrically coupled to electrical conductor 140-1 and electrical conductor 140-2, and light source 160-X is configured to be electrically coupled to electrical conductor 140-1 and electrical conductor 140-2. Due to the configuration of the switching apparatus 145 (discussed below) of the PCB assembly 125, all of the light sources 160 of the PCB assembly 125 receive their electrical flow through the electrical conductor 140-1 and not through (are bypassed by) the electrical conductor 140-2.

In alternative embodiments, when the switching apparatus 145 is in one configuration, some of the light sources 160 (e.g., light source 160-1) of the PCB assembly 125 receive their electrical flow through the electrical conductor 140-1 and not through (are bypassed by) the electrical conductor 140-2, while a reminder of the light sources 160 (e.g., light source 160-X) of the PCB assembly 125 receive their electrical flow through the electrical conductor 140-2 and not through (are bypassed by) the electrical conductor 140-1. When the switching apparatus 145 is in another configuration, the mirror effect can take place where some of the light sources 160 (e.g., light source 160-X) of the PCB assembly 125 receive their electrical flow through the electrical conductor 140-1 and not through (are bypassed by) the electrical conductor 140-2, while a reminder of the light sources 160 (e.g., light source 160-1) of the PCB assembly 125 receive their electrical flow through the electrical conductor 140-2 and not through (are bypassed by) the electrical conductor 140-1.

Each leg or branch of an electrical conductor 140 has a line resistance 191, which results in some amount of lost power in an amount proportional to the amount of line resistance 191 as electrical flow from a power source 110 flows through the leg or branch of the electrical conductor 140. In this case, the leg or branch of the electrical conductor 140-1 leading to light source 160-1 has line resistance 191-3, and the leg or branch of the electrical conductor 140-2 leading to light source 160-1 has line resistance 191-4. Further, the leg or branch of the electrical conductor 140-1 leading to light source 160-X has line resistance 191-5, and the leg or branch of the electrical conductor 140-2 leading to light source 160-X has line resistance 191-6. The amount of line resistance 191 (and so the amount of corresponding line loss) in the leg or branch of an electrical conductor 140 can be based on one or more of a number of factors, including but not limited to the material of the leg or branch of the electrical conductor 140, the length of the leg or branch of the electrical conductor 140, the ambient temperature, the ambient humidity level, and the size of the leg or branch of the electrical conductor 140.

The distal ends of electrical conductor 140-1 and electrical conductor 140-2 are electrically coupled to another connector portion 135-2 (discussed below) of the PCB assembly 125. Through this connector portion 135-2, the distal ends of electrical conductor 140-1 and electrical conductor 140-2 are indirectly electrically coupled to the proximal ends of electrical conductor 1140-1 and electrical conductor 1140-2 of the PCB assembly 1125 through another connector portion 1135-1 of the PCB assembly 1125. The connector portion 135-2 at the distal end of the electrical conductors 140 of the PCB assembly 125 can be directly coupled to the connector portion 1135-1 at the proximal end of the electrical conductors 1140 of the PCB assembly 1125. Alternatively, there can be an electrical cable (e.g., similar to the electrical cable 104 discussed above) that provides the electrical communication between the connector portion 135-2 at the distal end of the electrical conductors 140 of the PCB assembly 125 and the connector portion 1135-1 at the proximal end of the electrical conductors 1140 of the PCB assembly 1125.

Extending from the connector portion 1135-1 of the PCB assembly 1125 are the multiple electrical conductors 1140 in the PCB 1120 of the PCB assembly 1125. In this way, the electrical conductors 1140 are electrically coupled to the electrical conductors 140 in the PCB 120 of the PCB assembly 125. In this example, electrical conductor 1140-1 is electrically coupled to electrical conductor 140-1, and electrical conductor 1140-2 is electrically coupled to electrical conductor 140-2. In some cases, a single electrical conductor 140 of the PCB 120 is electrically coupled to a single electrical conductor 1140 of the PCB 1120. Alternatively, an electrical conductor 140 of the PCB 120 is electrically coupled to multiple electrical conductors 1140 of the PCB 1120.

Each electrical conductor 1140 of the PCB 1120 is or includes one or more of a number of electrically-conductive material (e.g., aluminum, copper) that is disposed in a channel of the body 1131 of the PCB 1120. Such a channel can be within the body 1131 (thereby encapsulating the electrical conductor 140) or on an outer surface of the body 1131 (thereby allowing part of the electrical conductor 1140 to be exposed) of the PCB 1120. An electrical conductor 1140 can be called a trace in some cases. As discussed below, the distal end of each electrical conductor 1140 is electrically coupled to a connector portion 1135-2 of the PCB assembly 1125. Such a connector portion 1135-2 can be configured to couple to another component (e.g., a connector portion of another PCB assembly) of the extended light fixture. In some cases, as when the PCB assembly 1125 is the distal-most component of the extended light fixture 199, the connector portion 1135-2 can be an open connection.

Each electrical conductor 1140 has a line resistance 191, which results in some amount of lost power in an amount proportional to the amount of line resistance 191 as electrical flow, originating from a power source 110 and then flowing through an electrical conductor 140 of the PCB assembly 125, flows through the electrical conductor 1140. In this case, electrical conductor 1140-1 has line resistance 191-13, and electrical conductor 1140-2 has line resistance 191-14. The amount of line resistance 191 (and so the amount of corresponding line loss) in an electrical conductor 1140 can be based on one or more of a number of factors, including but not limited to the material of the electrical conductor 1140, the length of the electrical conductor 1140, the ambient temperature, the ambient humidity level, and the size of the electrical conductor 1140.

The PCB 1120 has one or more light sources 1160 coupled thereto. For example, in this case, there can be Y light sources 1160 (light source 1160-1 through light source 1160-Y) coupled to the PCB 1120. Each light source 1160 is configured to emit light (e.g., to provide general illumination, to provide accent lighting) into a volume of space (e.g., a room, an office space). A light source 1160 can use any of a number of technologies (e.g., light-emitting diode (LED), incandescent, fluorescent, halogen) suitable for use with the extended light fixture 199. A light source 1160 can include one or more of a number of components in addition to a light source. Such components can include, but are not limited to, a converter, an inverter, a resistor, a diode, and a capacitor.

Each light source 1160 of the PCB assembly 1125 illuminates using power and/or control (e.g., dimming) provided by one of the electrical conductors 1140 in the PCB 1120. Under such a configuration, each electrical conductor 1140 can have one or more legs or branches within the PCB 1120. Each leg or branch of an electrical conductor 1140 can terminate at a light source 1160 coupled to the PCB 1120 at a light source receiver (discussed below). In some cases, as in this example, each electrical conductor 1140 has a leg or branch for each light source 1160. In alternative embodiments, a leg or branch from an electrical conductor 1140 can provide power to multiple light sources 1160 through the use of sub-branches or similar configurations. In certain example embodiments, each light source 1160 of the PCB assembly 1125 is configured to be electrically coupled to one or more of the electrical conductors 1140. For example, in this case, light source 1160-1 is configured to be electrically coupled to electrical conductor 1140-1 and electrical conductor 1140-2, and light source 1160-Y is configured to be electrically coupled to electrical conductor 1140-1 and electrical conductor 1140-2. Due to the configuration of the switching apparatus 1145 (discussed below) of the PCB assembly 1125, all of the light sources 1160 of the PCB assembly 1125 receive their electrical flow through the electrical conductor 1140-2 and not through (are bypassed by) the electrical conductor 1140-1.

In alternative embodiments, when the switching apparatus 1145 is in one configuration, some of the light sources 1160 (e.g., light source 1160-1) of the PCB assembly 1125 receive their electrical flow through the electrical conductor 1140-1 and not through (are bypassed by) the electrical conductor 1140-2, while a reminder of the light sources 1160 (e.g., light source 1160-X) of the PCB assembly 1125 receive their electrical flow through the electrical conductor 1140-2 and not through (are bypassed by) the electrical conductor 1140-1. When the switching apparatus 1145 is in another configuration, the mirror effect can take place where some of the light sources 1160 (e.g., light source 1160-X) of the PCB assembly 1125 receive their electrical flow through the electrical conductor 1140-1 and not through (are bypassed by) the electrical conductor 1140-2, while a reminder of the light sources 1160 (e.g., light source 1160-1) of the PCB assembly 1125 receive their electrical flow through the electrical conductor 1140-2 and not through (are bypassed by) the electrical conductor 1140-1.

Each leg or branch of an electrical conductor 1140 of the PCB 1120 has a line resistance 191, which results in some amount of lost power in an amount proportional to the amount of line resistance 191 as electrical flow flows through the leg or branch of the electrical conductor 1140. In this case, the leg or branch of the electrical conductor 140-1 leading to light source 1160-1 has line resistance 191-7, and the leg or branch of the electrical conductor 1140-2 leading to light source 1160-1 has line resistance 191-8. Further, the leg or branch of the electrical conductor 1140-1 leading to light source 1160-Y has line resistance 191-9, and the leg or branch of the electrical conductor 1140-2 leading to light source 1160-Y has line resistance 191-10. The amount of line resistance 191 (and so the amount of corresponding line loss) in the leg or branch of an electrical conductor 1140 can be based on one or more of a number of factors, including but not limited to the material of the leg or branch of the electrical conductor 1140, the length of the leg or branch of the electrical conductor 1140, the ambient temperature, the ambient humidity level, and the size of the leg or branch of the electrical conductor 1140.

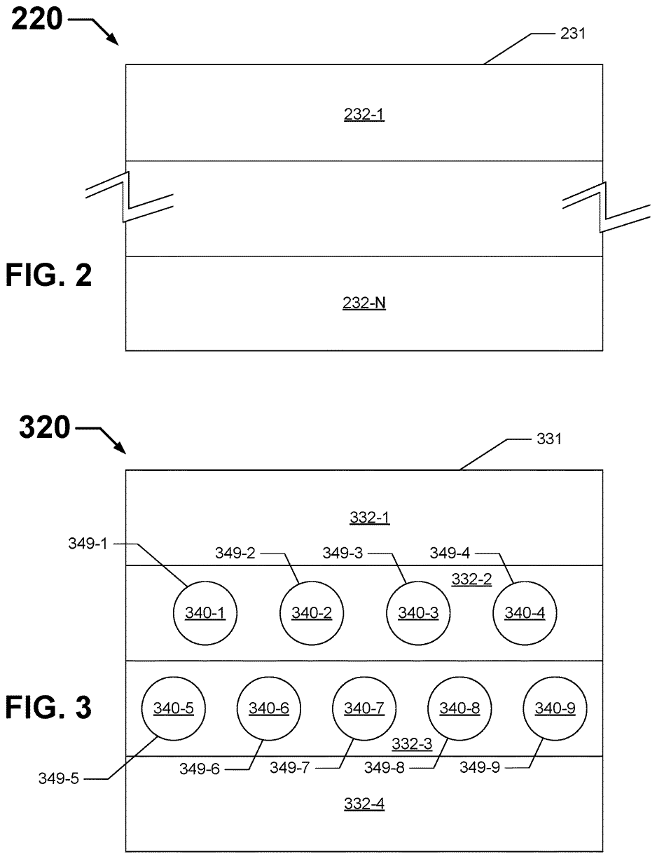

FIG. 2 shows a front sectional view of a PCB 220 of an extended light fixture according to certain example embodiments. Referring to FIGS. 1 and 2, the PCB 220 of FIG. 2 has a body 231 with multiple layers 232 (layer 232-1 through layer 232-N). A layer 232 of the PCB 220 can include and/or have features to receive one or more components of an associated PCB assembly. For example, layer 232-1 of the PCB 220 of FIG. 2 can include traces and receiving features that are configured to received discrete components (e.g., integrated circuits, resistors, capacitors, resistors, heat sinks) of a PCB assembly. In some cases, the PCB 220 can have only a single layer 232. When the PCB 220 has multiple layers 232, each layer 232 can be added incrementally during a manufacturing process for the PCB 220. Regardless of how many layers 232 the PCB 220 has, the body 231 of the PCB 220 can be rigid, flexible, or bendable.

FIG. 3 shows various views of a front sectional view of another PCB 320 of an extended light fixture according to certain example embodiments. Referring to FIGS. 1 through 3, the PCB 320 of FIG. 3 has four layers 332. The top layer 332-1 and the bottom layer 332-4 do not show any features for the sake of simplicity, although layer 332-1 and layer 332-4 can, in actuality, include and/or have features to receive one or more components of an associated PCB assembly. In some cases, layer 332-4 can be the first layer generated in manufacturing the PCB 320, and layer 332-1 can be the final layer generated in manufacturing the PCB 320.

Layer 332-3, located adjacent to the top of layer 332-4, is shown to have 5 channels 349 that are filled with an electrical conductor 340. In this case, electrical conductor 340-5 is positioned inside of channel 349-5, electrical conductor 340-6 is positioned inside of channel 349-6, electrical conductor 340-7 is positioned inside of channel 349-7, electrical conductor 340-8 is positioned inside of channel 349-8, and electrical conductor 340-9 is positioned inside of channel 349-9. Channel 349-5 through channel 349-9 (and so also electrical conductor 340-5 through electrical conductor 340-9) are substantially evenly distributed along the width of the layer 332-3 and are positioned along the approximate center of the height of the layer 332-3. In alternative embodiments, the channels 349 can have some other distribution (e.g., random spacing) within a layer 332.

Further, layer 332-2, located adjacent to the top of layer 332-3 and adjacent to the bottom of layer 332-1, is shown to have 4 channels 349 that are filled with an electrical conductor 340. In this case, electrical conductor 340-1 is positioned inside of channel 349-1, electrical conductor 340-2 is positioned inside of channel 349-2, electrical conductor 340-3 is positioned inside of channel 349-3, and electrical conductor 340-4 is positioned inside of channel 349-4. Channel 349-1 through channel 349-4 (and so also electrical conductor 340-1 through electrical conductor 340-4) are substantially evenly distributed along the width of the layer 332-2 and are positioned along the approximate center of the height of the layer 332-2. A channel 349 in a layer 332 in the body 331 of the PCB 320 can have one or more of any number of characteristics. For example, a channel 349 (and so also a corresponding electrical conductor 340) can have one or more of any of a number of cross-sectional shapes along its length. Examples of such shapes can include, but are not limited to, a circle (as in this example), a square, a semi-circle, and a rectangle. As another example, a channel 349 (and so also a corresponding electrical conductor 340) can have any of a number of cross-sectional areas along its length. As yet another example, a channel 349 (and so also a corresponding electrical conductor 340) can be straight or have any of a number of bends along its length. In some cases, as with the legs or branches discussed above, an electrical conductor 340 can have segments that branch out (e.g., at a right angle, at an acute angle, at an obtuse angle) from the main line of the electrical conductor 340 toward a light source receiving feature in the PCB 320. The distance between adjacent channels 349, the thickness of a layer 332, and the total number of channels 349 in a layer 332 can be limited by factors such as electromagnetic influences of the electrical conductor 340 in one channel 349 on another electrical conductor 340 in an adjacent channel 349.

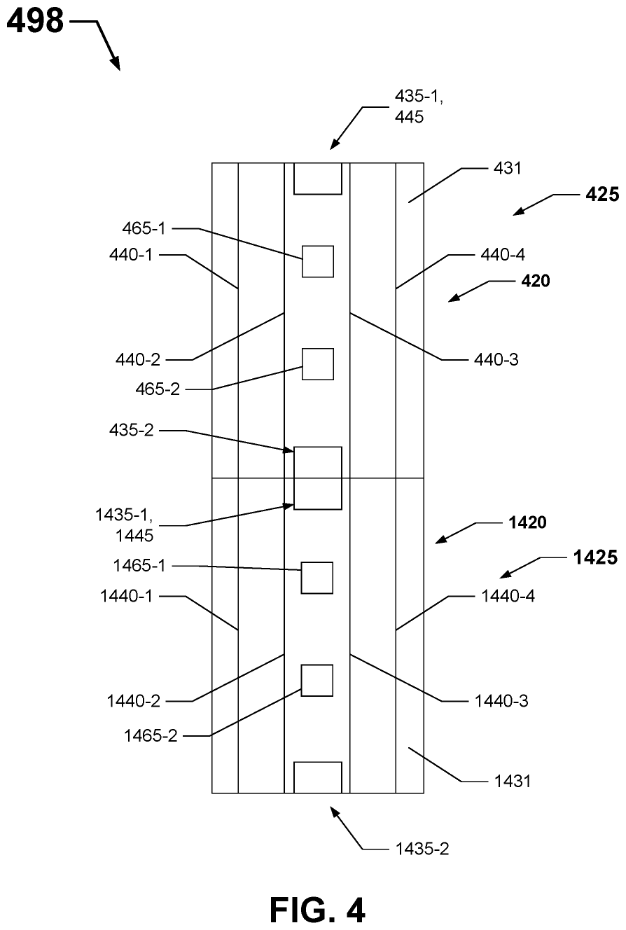

FIG. 4 shows a top view of an assembly 498 of an extended light fixture according to certain example embodiments. Referring to FIGS. 1 through 4, the assembly 498 of FIG. 4 includes two PCB assemblies (PCB assembly 425 and PCB assembly 1425) that are coupled to each other. The PCB assembly 425 includes a PCB 420 having body 431 with four electrical conductors 440 (electrical conductor 440-1, electrical conductor 440-2, electrical conductor 440-3, and electrical conductor 440-4) disposed in a channel (e.g., similar to a channel 349 discussed above) in the top surface of the top layer (e.g., similar to a layer 232 discussed above) of the body 431.

In some cases, electrical conductor 440-1 and electrical conductor 440-2 can be configured to carry a positive and negative leg of a DC circuit, and electrical conductor 440-3 and electrical conductor 440-4 can be configured to carry a positive and negative leg of another DC circuit. In alternative cases, electrical conductor 440-1 can be configured to carry a phase of an AC circuit, electrical conductor 440-2 can be configured as a neutral leg of the AC circuit, electrical conductor 440-3 can be configured to carry another phase of an AC circuit, and electrical conductor 440-4 can be configured to carry a communication signal.

At the top end of PCB 420, positioned proximate to the outer perimeter of the body 431, is a connector portion 435-1 and a switching apparatus 445. The connector portion 435-1 can be configured to couple to another component (e.g., a power source 110, an electrical cable 104, another PCB) of an extended light fixture. Underneath the top surface of the top layer of the body 431 of the PCB 420, the connector portion 435-1 provides electrical continuity to the top end of all four electrical conductors 440. The switching apparatus 445, which in this case is integrated with the connector portion 435-1, is in communication with the electrical conductors 440. The switching apparatus 445 can have multiple configurations that are selectable by a user. The configuration of the switching apparatus 445 can determine which light sources (coupled to light source receiving features 465 of the PCB 420) are in electrical continuity with particular electrical conductors 440 of the PCB 420.

For example, when the switching apparatus 445 is in a first configuration, as in this example, the switching apparatus 445 enables electrical conductor 440-1 and electrical conductor 440-2. In other words, when the switching apparatus 445 is in the first configuration, the switching apparatus 445 allows electrical conductor 440-1 and electrical conductor 440-2 to be in electrical continuity (through legs or branches in electrical conductor 440-1 and electrical conductor 440-2) with all of the light source receiving features 465 (in this case, light source receiving feature 465-1 and light source receiving features 465-2) of the PCB 420.

In some cases, as in this example, when the switching apparatus 445 is in the first configuration, electrical conductor 440-3 and electrical conductor 440-4 have no electrical continuity with any of the light source receiving features 465 of the PCB 420. As a result, any electrical flow (e.g., power, control signals) that enters the top end of electrical conductor 440-3 and electrical conductor 440-4 continues to the bottom end of electrical conductor 440-3 and electrical conductor 440-4 without any losses except for the line resistance (e.g., similar to line resistance 191 discussed above) in electrical conductor 440-3 and electrical conductor 440-4.

Continuing with the example, when the switching apparatus 445 is in a second configuration, the switching apparatus 445 enables electrical conductor 440-3 and electrical conductor 440-4. In other words, when the switching apparatus 445 is in the second configuration, the switching apparatus 445 allows electrical conductor 440-3 and electrical conductor 440-4 to be in electrical continuity (through legs or branches in electrical conductor 440-3 and electrical conductor 440-4) with all of the light source receiving features 465 (in this case, light source receiving feature 465-1 and light source receiving features 465-2) of the PCB 420.

In some cases, when the switching apparatus 445 is in the second configuration, electrical conductor 440-1 and electrical conductor 440-2 have no electrical continuity with any of the light source receiving features 465 of the PCB 420. As a result, any electrical flow (e.g., power, control signals) that enters the top end of electrical conductor 440-1 and electrical conductor 440-2 continues to the bottom end of electrical conductor 440-1 and electrical conductor 440-2 without any losses except for the line resistance (e.g., similar to line resistance 191 discussed above) in electrical conductor 440-1 and electrical conductor 440-2.

At the bottom end of PCB 420, positioned proximate to the outer perimeter of the body 431, is a connector portion 435-2. Underneath the top surface of the top layer of the body 431 of the PCB 420, the connector portion 435-2 provides electrical continuity to the bottom end of all four electrical conductors 440. While the connector portion 435-2 in this case is located at the opposite end of the PCB 420 relative to the connector portion 435-1, in alternative embodiments one or both connector ends can be positioned at different locations on the PCB 420, whether or not along the outer perimeter of the PCB 420. In any case, all of the electrical conductors 440 of the PCB 420 run continuously between connector portion 435-1 and connector portion 435-2. The configuration of the connector portion 435-2 can be complementary to the configuration of the connector portion 435-1. Alternatively, the configuration of the connector portion 435-2 can be unrelated to the configuration of the connector portion 435-1. The connector portion 435-2 of the PCB assembly 425 is coupled to connector portion 1435-1 of the PCB assembly 1425, and so the configuration of the connector portion 435-2 is complementary to the configuration of the connector portion 1435-1 in this example.

The configuration of the PCB assembly 1425 is substantially the same as the configuration of the PCB assembly 425. For example, at the top end of PCB 1420, positioned proximate to the outer perimeter of the body 1431, is a connector portion 1435-1 and a switching apparatus 1445. Underneath the top surface of the top layer of the body 1431 of the PCB 1420, the connector portion 1435-1 provides electrical continuity to the top end of all four electrical conductors 1440. The switching apparatus 1445, which in this case is integrated with the connector portion 1435-1, is in communication with the electrical conductors 1440. The switching apparatus 1445 can have multiple configurations that are selectable by a user. The configuration of the switching apparatus 1445 can determine which light sources (coupled to light source receiving features 1465 of the PCB 1420) are in electrical continuity with particular electrical conductors 1440 of the PCB 1420.

For example, when the switching apparatus 1445 is in a first configuration, as in this example, the switching apparatus 1445 enables electrical conductor 1440-3 and electrical conductor 1440-4. In other words, when the switching apparatus 1445 is in the first configuration, the switching apparatus 1445 allows electrical conductor 1440-3 and electrical conductor 1440-4 to be in electrical continuity (through legs or branches in electrical conductor 1440-3 and electrical conductor 1440-4) with all of the light source receiving features 1465 (in this case, light source receiving feature 1465-1 and light source receiving features 1465-2) of the PCB 1420.

In some cases, as in this example, when the switching apparatus 1445 is in the first configuration, electrical conductor 1440-1 and electrical conductor 1440-2 have no electrical continuity with any of the light source receiving features 1465 of the PCB assembly 1425. As a result, any electrical flow (e.g., power, control signals) that enters the top end of electrical conductor 1440-1 and electrical conductor 1440-2 continues to the bottom end of electrical conductor 1440-1 and electrical conductor 1440-2 without any losses except for the line resistance (e.g., similar to line resistance 191 discussed above) in electrical conductor 1440-1 and electrical conductor 1440-2.

Continuing with the example, when the switching apparatus 1445 is in a second configuration, the switching apparatus 1445 enables electrical conductor 1440-1 and electrical conductor 1440-2. In other words, when the switching apparatus 1445 is in the second configuration, the switching apparatus 1445 allows electrical conductor 1440-1 and electrical conductor 1440-2 to be in electrical continuity (through legs or branches in electrical conductor 1440-1 and electrical conductor 1440-2) with all of the light source receiving features 1465 (in this case, light source receiving feature 1465-1 and light source receiving features 1465-2) of the PCB 420.

In some cases, when the switching apparatus 1445 is in the second configuration, electrical conductor 1440-3 and electrical conductor 1440-4 have no electrical continuity with any of the light source receiving features 1465 of the PCB 1420. As a result, any electrical flow (e.g., power, control signals) that enters the top end of electrical conductor 1440-3 and electrical conductor 1440-4 continues to the bottom end of electrical conductor 1440-3 and electrical conductor 1440-4 without any losses except for the line resistance (e.g., similar to line resistance 191 discussed above) in electrical conductor 1440-3 and electrical conductor 1440-4.

At the bottom end of PCB 1420, positioned proximate to the outer perimeter of the body 1431, is a connector portion 1435-2. Underneath the top surface of the top layer of the body 1431 of the PCB 1420, the connector portion 1435-2 provides electrical continuity to the bottom end of all four electrical conductors 1440. While the connector portion 1435-2 in this case is located at the opposite end of the PCB 1420 relative to the connector portion 1435-1, in alternative embodiments one or both connector ends can be positioned at different locations on the PCB 1420, whether or not along the outer perimeter of the PCB 1420. In any case, all of the electrical conductors 1440 of the PCB 1420 run continuously between connector portion 1435-1 and connector portion 1435-2. The configuration of the connector portion 1435-2 can be complementary to the configuration of the connector portion 1435-1. Alternatively, the configuration of the connector portion 1435-2 can be unrelated to the configuration of the connector portion 1435-1. In this case, the connector portion 1435-2 is not connected to another component of an extended light fixture.

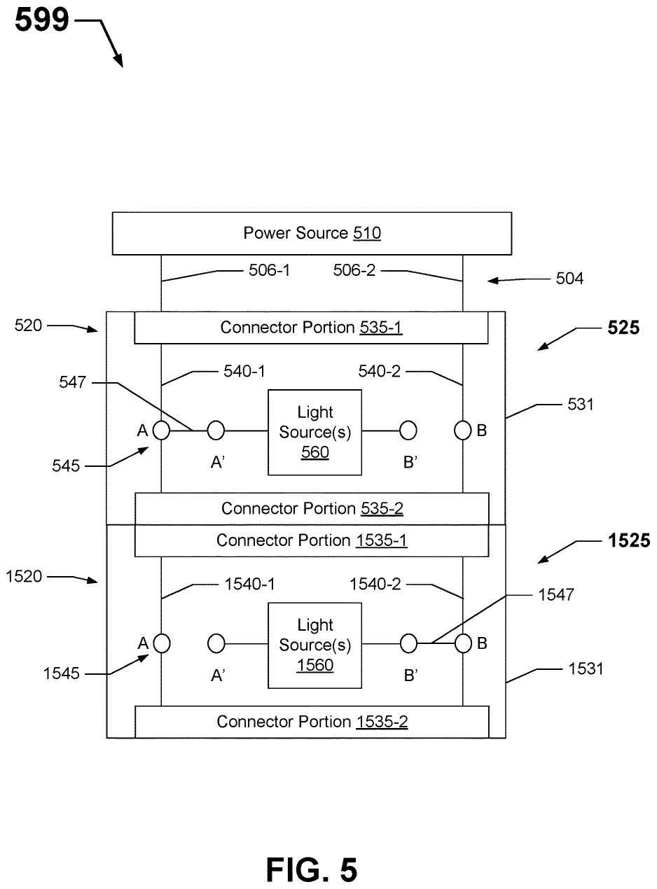

FIG. 5 shows a system diagram of an extended light fixture 599 according to certain example embodiments. Referring to FIGS. 1 through 5, the extended light fixture 599 of FIG. 5 includes a power source 510 and two PCB assemblies (PCB assembly 525 and PCB assembly 1525) that are coupled to each other. The power source 510 is electrically coupled to a connector portion 535-1 of the PCB assembly 525 by two wires 506 (wire 506-1 and wire 506-2) of an electrical cable 504. The power source 510, the electrical cable 504, the electrical wires 506, and the PCB assemblies (PCB assembly 525 and PCB assembly 1525), including components thereof such as the PCBs and the switching apparatuses, are substantially the same as the power sources 110, the electrical cable 104, the wires 106, and the PCB assemblies, including corresponding components thereof, discussed above.

In this case, the power flow from the power source 510 through the wire 506-1 of the electrical cable 504 flows through the connector portion 535-1 of the PCB assembly 525 to electrical conductor 540-1 of the PCB assembly 525. Similarly, the power flow from the power source 510 through the wire 506-2 of the electrical cable 504 flows through the connector portion 535-2 of the PCB assembly 525 to electrical conductor 540-2 of the PCB 520. The PCB assembly 525 includes one or more light sources 560 that are powered by the power flow from the power source 510.

Electrical conductor 540-1 of the PCB assembly 525 has a main segment that runs between connector portion 535-1 and connector portion 535-2 of the PCB assembly 525. The electrical conductor 540-1 also has one or more legs or branches having electrical connectivity to the one or more light sources 560 disposed on the PCB 520. In this case, there is one leg or branch of the electrical conductor 540-1 for each light source 560. Each leg or branch of the electrical conductor 540-1 is electrically separated from the main segment of the electrical conductor 540-1 in its default state.

Similarly, electrical conductor 540-2 of the PCB assembly 525 has a main segment that runs between connector portion 535-1 and connector portion 535-2 of the PCB assembly 525. The electrical conductor 540-2 also has one or more legs or branches having electrical connectivity to the one or more light sources 560. In this case, there is one leg or branch of the electrical conductor 540-2 for each light source 560. Each leg or branch of the electrical conductor 540-2 is electrically separated from the main segment of the electrical conductor 540-2 in its default state.

A switching apparatus 545 of the PCB assembly 525 is used to determine which of the legs or branches of an electrical conductor 540 becomes electrically connected to the main segment of that electrical conductor 540. In this example, the switching apparatus 545 is not integrated with the connector portion 535-1. Instead, the switching apparatus 545 in this case includes an electrically-conductive jumper 547 (e.g., a zero-ohm resistor) that is inserted into a subset of the receiving features disposed in the body 531 of the PCB 520. In this case, there are four receiving features (receiving feature A, receiving feature A′, receiving feature B, and receiving feature B′), wherein one subset is made up of receiving feature A and receiving feature A′, and where the other subset is made up of receiving feature B and receiving feature B′. As defined herein, such receiving features can also be called jumper receiving features or switching apparatus receiving features.

Each of the receiving features is in electrical communication with part of one of the electrical conductors 540. In this case, receiving feature A is in electrical communication with the main segment of the electrical conductor 540-1. Receiving feature A′ is in electrical communication with the legs or branches of electrical conductor 540-1 leading to the light sources 560. Receiving feature B is in electrical communication with the main segment of the electrical conductor 540-2. Receiving feature B′ is in electrical communication with the legs or branches of electrical conductor 540-2 leading to the light sources 560.

When the jumper 547 is placed in receiving feature A and receiving feature A′ (which can be referred to as a subset of the receiving features), as shown in FIG. 5, power flow in the main segment of the electrical conductor 540-1 flows through the jumper 547 and through the legs or branches of the electrical conductor 540-1 to the light sources 560. In such a case, with the jumper 547 placed in receiving feature A and receiving feature A′, the switching apparatus 545 of the PCB assembly 525 can be in one (e.g., a first) configuration. When the jumper 547 is not inserted into receiving feature A and receiving feature A′, the electrical flow from the connector portion 535-1 to the main segment of the electrical conductor 540-1 goes straight to the connector portion 535-2 of the PCB assembly 525 without any of the electrical flow being diverted to any of the legs or branches of the electrical conductor 540-1.

If the jumper 547 is placed in receiving feature B and receiving feature B′ (which can be referred to as a subset of the receiving features), power flow in the main segment of the electrical conductor 540-2 flows through the jumper 547 and through the legs or branches of the electrical conductor 540-2 to the light sources 560. In such a case, with the jumper 547 placed in receiving feature B and receiving feature B′, the switching apparatus 545 of the PCB assembly 525 can be in another (e.g., a second) configuration. When the jumper 547 is not inserted into receiving feature B and receiving feature B′, as shown in FIG. 5, the electrical flow from the connector portion 535-1 to the main segment of the electrical conductor 540-2 goes straight to the connector portion 535-2 of the PCB assembly 525 without any of the electrical flow being diverted to any of the legs or branches of the electrical conductor 540-2.

The connector portion 535-2 of the PCB assembly 525 is connected to the connector portion 1535-1 of the PCB assembly 1525. In this way, the configuration of the connector portion 535-2 complements the configuration of the connector portion 1535-1. As a result, the main segment of electrical conductor 540-1 is in electrical communication with the main segment of electrical conductor 1540-1 of the PCB 1520 of the PCB assembly 1525, the main segment of electrical conductor 540-2 is in electrical communication with the main segment of electrical conductor 1540-2 of the PCB 1520 of the PCB assembly 1525.

Electrical conductor 1540-1 of the PCB assembly 1525 has a main segment that runs between connector portion 1535-1 and connector portion 1535-2 of the PCB assembly 1525. The electrical conductor 1540-1 also has one or more legs or branches having electrical connectivity to the one or more light sources 1560 disposed on the PCB 1520. In this case, there is one leg or branch of the electrical conductor 1540-1 for each light source 1560. Each leg or branch of the electrical conductor 1540-1 is electrically separated from the main segment of the electrical conductor 1540-1 in its default state.

Similarly, electrical conductor 1540-2 of the PCB assembly 1525 has a main segment that runs between connector portion 1535-1 and connector portion 1535-2 of the PCB assembly 1525. The electrical conductor 1540-2 also has one or more legs or branches having electrical connectivity to the one or more light sources 1560. In this case, there is one leg or branch of the electrical conductor 1540-2 for each light source 1560. Each leg or branch of the electrical conductor 1540-2 is electrically separated from the main segment of the electrical conductor 1540-2 in its default state.

A switching apparatus 1545 of the PCB assembly 1525 is used to determine which of the legs or branches of an electrical conductor 1540 becomes electrically connected to the main segment of that electrical conductor 1540. In this example, the switching apparatus 1545 is not integrated with the connector portion 1535-1. Instead, the switching apparatus 1545 in this case includes an electrically-conductive jumper 1547 (e.g., a zero-ohm resistor) that is inserted into a subset of the receiving features disposed in the body 1531 of the PCB 1520. In this case, there are four receiving features (receiving feature A, receiving feature A′, receiving feature B, and receiving feature B′), where one subset is made up of receiving feature A and receiving feature A′, and where the other subset is made up of receiving feature B and receiving feature B′.

Each of the receiving features is in electrical communication with part of one of the electrical conductors 1540. In this case, receiving feature A is in electrical communication with the main segment of the electrical conductor 1540-1. Receiving feature A′ is in electrical communication with the legs or branches of electrical conductor 1540-1 leading to the light sources 1560. Receiving feature B is in electrical communication with the main segment of the electrical conductor 1540-2. Receiving feature B′ is in electrical communication with the legs or branches of electrical conductor 1540-2 leading to the light sources 1560.

If the jumper 1547 is placed in receiving feature A and receiving feature A′, power flow in the main segment of the electrical conductor 1540-1 flows through the jumper 1547 and through the legs or branches of the electrical conductor 1540-1 to the light sources 1560. In such a case, with the jumper 1547 placed in receiving feature A and receiving feature A′, the switching apparatus 1545 of the PCB assembly 1525 can be in one (e.g., a first) configuration. When the jumper 1547 is not inserted into receiving feature A and receiving feature A′, as shown in FIG. 5, the electrical flow from the connector portion 1535-1 to the main segment of the electrical conductor 1540-1 goes straight to the connector portion 1535-2 of the PCB assembly 1525 without any of the electrical flow being diverted to any of the legs or branches of the electrical conductor 1540-1.

When the jumper 1547 is placed in receiving feature B and receiving feature B′, as shown in FIG. 5, power flow in the main segment of the electrical conductor 1540-2 flows through the jumper 1547 and through the legs or branches of the electrical conductor 1540-2 to the light sources 1560. In such a case, with the jumper 1547 placed in receiving feature B and receiving feature B′, the switching apparatus 1545 of the PCB assembly 1525 can be in another (e.g., a second) configuration. If the jumper 1547 is not inserted into receiving feature B and receiving feature B′, the electrical flow from the connector portion 1535-1 to the main segment of the electrical conductor 1540-2 goes straight to the connector portion 1535-2 of the PCB assembly 1525 without any of the electrical flow being diverted to any of the legs or branches of the electrical conductor 1540-2. The connector portion 1535-2 of the PCB assembly 1525 is not connected to any other component of the extended light fixture 599.

With this configuration of the switching apparatus 545 of the PCB assembly 525 and the switching apparatus 1545 of the PCB assembly 1525, approximately half of the total electrical demand (represented by the light sources 560) of the extended light fixture 599 are served through electrical conductor 540-1, and the other half of the total electrical demand (represented by the light sources 1560) of the extended light fixture 599 are served through electrical conductor 1540-2. In this case, the single power source 510 provides electrical flow (e.g., power, dimming, control) to series-connected electrical conductor 540-1 and electrical conductor 1540-1 and to series-connected electrical conductor 540-2 and electrical conductor 1540-2 in parallel with each other. This allows for additional PCB assemblies to be added to the extended light fixture 599 and/or for the distances between the power source 510, PCB assembly 525, and/or PCB assembly 1525 to be extended without compromising the performance of the extended light fixture. This arrangement can be useful when the extended light fixture 599 is part of a Class 2 system (as defined by the NEC), which limits the power output of the power source 510 to 100 W.

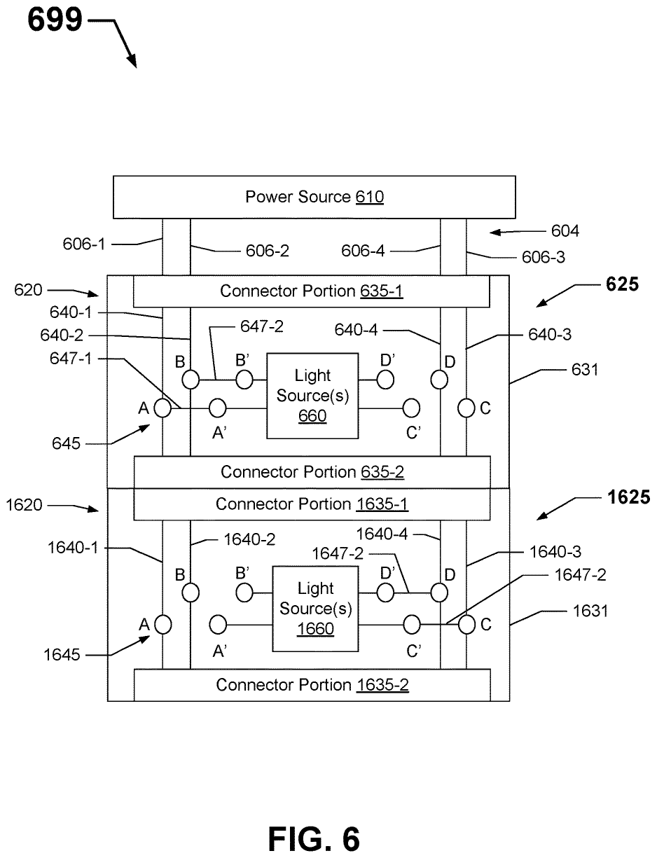

FIG. 6 shows a system diagram of another extended light fixture 699 according to certain example embodiments. Referring to FIGS. 1 through 6, the extended light fixture 699 of FIG. 6 is substantially the same as the extended light fixture 599 of FIG. 5 in that the extended light fixture 699 includes a power source 610 and two PCB assemblies (PCB assembly 625 and PCB assembly 1625) that are coupled to each other. In this case, the power source 610 is electrically coupled to a connector portion 1635-1 of the PCB assembly 1625 by four wires 606 (wire 606-1, wire 606-2, wire 606-3, and wire 606-4) of an electrical cable 604. The power source 610, the electrical cable 604, the wires 606, and the PCB assemblies (PCB assembly 625 and PCB assembly 1625), including components thereof such as the PCBs and the switching apparatuses, are substantially the same as the power sources, the electrical cables, the wires, and the PCB assemblies, including corresponding components thereof, discussed above.

In this case, the power flow from the power source 610 through the wire 606-1 and the wire 606-2 of the electrical cable 604 flows through the connector portion 635-1 of the PCB assembly 625 to electrical conductor 640-1 and electrical conductor 640-2, respectively, of the PCB assembly 625. Similarly, the power flow from the power source 610 through the wire 606-3 and the wire 606-4 of the electrical cable 604 flows through the connector portion 635-2 of the PCB assembly 625 to electrical conductor 640-3 and electrical conductor 640-4, respectively, of the PCB 620. The PCB assembly 625 includes one or more light sources 660 that are powered by the power flow from the power source 610. This configuration of the extended light fixture 699 can be used when the power source 610 is providing DC power to the PCB assemblies. In such a case, wire 606-1 can transport one leg (e.g., the positive leg) and wire 606-2 can transport the other leg (e.g., the negative leg) of DC power, while wire 606-3 can transport one leg (e.g., the positive leg) and wire 606-4 can transport the other leg (e.g., the negative leg) of DC power in parallel.

Electrical conductor 640-1 of the PCB assembly 625 has a main segment that runs between connector portion 635-1 and connector portion 635-2 of the PCB assembly 625. The electrical conductor 640-1 also has one or more legs or branches having electrical connectivity to the one or more light sources 660 disposed on the PCB 620. In this case, there is one leg or branch of the electrical conductor 640-1 for each light source 660. Each leg or branch of the electrical conductor 640-1 is electrically separated from the main segment of the electrical conductor 640-1 in its default state.

In addition, electrical conductor 640-2 of the PCB assembly 625 has a main segment that runs between connector portion 635-1 and connector portion 635-2 of the PCB assembly 625. The electrical conductor 640-2 also has one or more legs or branches having electrical connectivity to the one or more light sources 660 disposed on the PCB 620. In this case, there is one leg or branch of the electrical conductor 640-2 for each light source 660.

Each leg or branch of the electrical conductor 640-2 is electrically separated from the main segment of the electrical conductor 640-2 in its default state.

Similarly, electrical conductor 640-3 of the PCB assembly 625 has a main segment that runs between connector portion 635-1 and connector portion 635-2 of the PCB assembly 625. The electrical conductor 640-3 also has one or more legs or branches having electrical connectivity to the one or more light sources 660. In this case, there is one leg or branch of the electrical conductor 640-3 for each light source 660. Each leg or branch of the electrical conductor 640-3 is electrically separated from the main segment of the electrical conductor 640-3 in its default state.

In addition, electrical conductor 640-4 of the PCB assembly 625 has a main segment that runs between connector portion 635-1 and connector portion 635-2 of the PCB assembly 625. The electrical conductor 640-4 also has one or more legs or branches having electrical connectivity to the one or more light sources 660 disposed on the PCB 620. In this case, there is one leg or branch of the electrical conductor 640-4 for each light source 660. Each leg or branch of the electrical conductor 640-4 is electrically separated from the main segment of the electrical conductor 640-4 in its default state.

A switching apparatus 645 of the PCB assembly 625 is used to determine which of the legs or branches of a pair of electrical conductors 640 becomes electrically connected to the main segment of those electrical conductors 640. In this example, the switching apparatus 645 is not integrated with the connector portion 635-1. Instead, the switching apparatus 645 in this case includes one or more electrically-conductive jumpers 647 (e.g., a zero-ohm resistor) that are inserted into one or more subsets of the receiving features disposed in the body 631 of the PCB 620. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

Each of the receiving features is in electrical communication with part of one of the electrical conductors 640. In this case, receiving feature A is in electrical communication with the main segment of the electrical conductor 640-1. Receiving feature A′ is in electrical communication with the legs or branches of electrical conductor 640-1 leading to the light sources 660. Receiving feature B is in electrical communication with the main segment of the electrical conductor 640-2. Receiving feature B′ is in electrical communication with the legs or branches of electrical conductor 640-2 leading to the light sources 660. Receiving feature C is in electrical communication with the main segment of the electrical conductor 640-3. Receiving feature C′ is in electrical communication with the legs or branches of electrical conductor 640-3 leading to the light sources 660. Receiving feature D is in electrical communication with the main segment of the electrical conductor 640-4.

Receiving feature D′ is in electrical communication with the legs or branches of electrical conductor 640-4 leading to the light sources 660.

When a jumper 647 (e.g., jumper 647-1) is placed in receiving feature A and receiving feature A′, as shown in FIG. 6, power flow in the main segment of the electrical conductor 640-1 flows through the jumper 647-1 and through the legs or branches of the electrical conductor 640-1 to the light sources 660. In such a case, with the jumper 647-1 placed in receiving feature A and receiving feature A′, the switching apparatus 645 of the PCB assembly 625 can be in one (e.g., a first) configuration. When a jumper 647 is not inserted into receiving feature A and receiving feature A′, the electrical flow from the connector portion 635-1 to the main segment of the electrical conductor 640-1 goes straight to the connector portion 635-2 of the PCB assembly 625 without any of the electrical flow being diverted to any of the legs or branches of the electrical conductor 640-1.

If a jumper 647 (e.g., jumper 647-2) is placed in receiving feature B and receiving feature B′, as shown in FIG. 6, power flow in the main segment of the electrical conductor 640-2 flows through the jumper 647-2 and through the legs or branches of the electrical conductor 640-2 to the light sources 660. In such a case, with the jumper 647-2 placed in receiving feature B and receiving feature B′, the switching apparatus 645 of the PCB assembly 625 can be part of the configuration that also electrically connects the main branch of the electrical conductor 640-1 to the legs or branches of the electrical conductor 640-1. When a jumper 647 is not inserted into receiving feature B and receiving feature B′, the electrical flow from the connector portion 635-1 to the main segment of the electrical conductor 640-2 goes straight to the connector portion 635-2 of the PCB assembly 625 without any of the electrical flow being diverted to any of the legs or branches of the electrical conductor 640-2.

When a jumper 647 is placed in receiving feature C and receiving feature C′, power flow in the main segment of the electrical conductor 640-3 flows through the jumper 647 and through the legs or branches of the electrical conductor 640-3 to the light sources 660. In such a case, with the jumper 647 placed in receiving feature C and receiving feature C′, the switching apparatus 645 of the PCB assembly 625 can be in one (e.g., a second) configuration. When a jumper 647 is not inserted into receiving feature C and receiving feature C′, as shown in FIG. 6, the electrical flow from the connector portion 635-1 to the main segment of the electrical conductor 640-3 goes straight to the connector portion 635-2 of the PCB assembly 625 without any of the electrical flow being diverted to any of the legs or branches of the electrical conductor 640-3.

If a jumper 647 is placed in receiving feature D and receiving feature D′, as shown in FIG. 6, power flow in the main segment of the electrical conductor 640-4 flows through the jumper 647 and through the legs or branches of the electrical conductor 640-4 to the light sources 660. In such a case, with the jumper 647 placed in receiving feature D and receiving feature D′, the switching apparatus 645 of the PCB assembly 625 can be part of the configuration that also electrically connects the main branch of the electrical conductor 640-3 to the legs or branches of the electrical conductor 640-3. When a jumper 647 is not inserted into receiving feature D and receiving feature D′, as shown in FIG. 6, the electrical flow from the connector portion 635-1 to the main segment of the electrical conductor 640-4 goes straight to the connector portion 635-2 of the PCB assembly 625 without any of the electrical flow being diverted to any of the legs or branches of the electrical conductor 640-4.

The switching apparatus 645 in this case can be configured so that jumper 647-1 must be inserted into receiving feature A and receiving feature A′, and that jumper 647-2 must simultaneously be inserted into receiving feature B and receiving feature B′, in order for the power flowing through the main branches of electrical conductor 640-1 and electrical conductor 640-2 to reach the light sources 660 through the legs or branches of electrical conductor 640-1 and electrical conductor 640-2. Similarly, the switching apparatus 645 in this case can be configured so a jumper 647 must be inserted into receiving feature C and receiving feature C′, and that another jumper 647 must simultaneously be inserted into receiving feature D and receiving feature D′, in order for the power flowing through the main branches of electrical conductor 640-3 and electrical conductor 640-4 to reach the light sources 660 through the legs or branches of electrical conductor 640-3 and electrical conductor 640-4.

In alternative embodiments, jumper 647-1 and jumper 647-2 are part of a single jumper 647. In such a case, the jumper 647 can be configured to engage receiving feature A and receiving feature A′ simultaneously with engaging receiving feature B and receiving feature B′ without crossing those paths. As yet another alternative, the switching apparatus 645 can be configured so that there are only 2 receiving features (e.g., receiving feature A and receiving feature A′) that are engaged by a single jumper 647. When this occurs, the jumper 647 triggers a reconfiguration of the switching apparatus 645 that allows for the simultaneous electrical communication between the main segment and the legs or branches of the electrical conductor 640-1 and between the main segment and the legs or branches of the electrical conductor 640-2. The switching apparatus 1645 and associated jumper(s) 1647 of the PCB assembly 1625 can be substantially the same as the switching apparatus 645 and associated jumper(s) 647 of the PCB assembly 625.

The connector portion 635-2 of the PCB assembly 625 is connected to the connector portion 1635-1 of the PCB assembly 1625. In this way, the configuration of the connector portion 635-2 complements the configuration of the connector portion 1635-1. As a result, the main segment of electrical conductor 640-1 is in electrical communication with the main segment of electrical conductor 1640-1 of the PCB 1620 of the PCB assembly 1625, the main segment of electrical conductor 640-2 is in electrical communication with the main segment of electrical conductor 1640-2 of the PCB 1620 of the PCB assembly 1625, the main segment of electrical conductor 640-3 is in electrical communication with the main segment of electrical conductor 1640-3 of the PCB 1620 of the PCB assembly 1625, and the main segment of electrical conductor 640-4 is in electrical communication with the main segment of electrical conductor 1640-4 of the PCB 1620 of the PCB assembly 1625.

Electrical conductor 1640-1 of the PCB assembly 1625 has a main segment that runs between connector portion 1635-1 and connector portion 1635-2 of the PCB assembly 1625. The electrical conductor 1640-1 also has one or more legs or branches having electrical connectivity to the one or more light sources 1660 disposed on the PCB 1620. In this case, there is one leg or branch of the electrical conductor 1640-1 for each light source 1660. Each leg or branch of the electrical conductor 1640-1 is electrically separated from the main segment of the electrical conductor 1640-1 in its default state.

In addition, electrical conductor 1640-2 of the PCB assembly 1625 has a main segment that runs between connector portion 1635-1 and connector portion 1635-2 of the PCB assembly 1625. The electrical conductor 1640-2 also has one or more legs or branches having electrical connectivity to the one or more light sources 1660 disposed on the PCB 1620. In this case, there is one leg or branch of the electrical conductor 1640-2 for each light source 1660. Each leg or branch of the electrical conductor 1640-2 is electrically separated from the main segment of the electrical conductor 1640-2 in its default state.

Similarly, electrical conductor 1640-3 of the PCB assembly 1625 has a main segment that runs between connector portion 1635-1 and connector portion 1635-2 of the PCB assembly 1625. The electrical conductor 1640-3 also has one or more legs or branches having electrical connectivity to the one or more light sources 1660. In this case, there is one leg or branch of the electrical conductor 1640-3 for each light source 1660. Each leg or branch of the electrical conductor 1640-3 is electrically separated from the main segment of the electrical conductor 1640-3 in its default state.

In addition, electrical conductor 1640-4 of the PCB assembly 1625 has a main segment that runs between connector portion 1635-1 and connector portion 1635-2 of the PCB assembly 1625. The electrical conductor 1640-4 also has one or more legs or branches having electrical connectivity to the one or more light sources 1660 disposed on the PCB 1620. In this case, there is one leg or branch of the electrical conductor 1640-4 for each light source 1660. Each leg or branch of the electrical conductor 1640-4 is electrically separated from the main segment of the electrical conductor 1640-4 in its default state.

A switching apparatus 1645 of the PCB assembly 1625 is used to determine which of the legs or branches of a pair of electrical conductors 1640 becomes electrically connected to the main segment of those electrical conductors 1640. In this example, the switching apparatus 1645 is not integrated with the connector portion 1635-1. Instead, the switching apparatus 1645 in this case includes one or more electrically-conductive jumpers 1647 (e.g., a zero-ohm resistor) that are inserted into one or more subsets of the receiving features disposed in the body 1631 of the PCB 1620. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

Each of the receiving features is in electrical communication with part of one of the electrical conductors 1640. In this case, receiving feature A is in electrical communication with the main segment of the electrical conductor 1640-1. Receiving feature A′ is in electrical communication with the legs or branches of electrical conductor 1640-1 leading to the light sources 1660. Receiving feature B is in electrical communication with the main segment of the electrical conductor 1640-2. Receiving feature B′ is in electrical communication with the legs or branches of electrical conductor 1640-2 leading to the light sources 1660. Receiving feature C is in electrical communication with the main segment of the electrical conductor 1640-3. Receiving feature C′ is in electrical communication with the legs or branches of electrical conductor 1640-3 leading to the light sources 1660. Receiving feature D is in electrical communication with the main segment of the electrical conductor 1640-4. Receiving feature D′ is in electrical communication with the legs or branches of electrical conductor 1640-4 leading to the light sources 1660.

When a jumper 1647 is placed in receiving feature A and receiving feature A′, power flow in the main segment of the electrical conductor 1640-1 flows through the jumper 1647 and through the legs or branches of the electrical conductor 1640-1 to the light sources 1660. In such a case, with the jumper 1647 placed in receiving feature A and receiving feature A′, the switching apparatus 1645 of the PCB assembly 1625 can be in one configuration. When a jumper 1647 is not inserted into receiving feature A and receiving feature A′, as shown in FIG. 6, the electrical flow from the connector portion 1635-1 to the main segment of the electrical conductor 1640-1 goes straight to the connector portion 1635-2 of the PCB assembly 1625 without any of the electrical flow being diverted to any of the legs or branches of the electrical conductor 1640-1.

If a jumper 1647 is placed in receiving feature B and receiving feature B′, as shown in FIG. 6, power flow in the main segment of the electrical conductor 1640-2 flows through the jumper 1647 and through the legs or branches of the electrical conductor 1640-2 to the light sources 1660. In such a case, with the jumper 1647 placed in receiving feature B and receiving feature B′, the switching apparatus 1645 of the PCB assembly 1625 can be part of the configuration that also electrically connects the main branch of the electrical conductor 1640-1 to the legs or branches of the electrical conductor 1640-1. When a jumper 1647 is not inserted into receiving feature B and receiving feature B′, as shown in FIG. 6, the electrical flow from the connector portion 1635-1 to the main segment of the electrical conductor 1640-2 goes straight to the connector portion 1635-2 of the PCB assembly 1625 without any of the electrical flow being diverted to any of the legs or branches of the electrical conductor 1640-2.

When a jumper 1647 (e.g., jumper 1647-1) is placed in receiving feature C and receiving feature C′, as shown in FIG. 6, power flow in the main segment of the electrical conductor 1640-3 flows through the jumper 1647-1 and through the legs or branches of the electrical conductor 1640-3 to the light sources 1660. In such a case, with the jumper 1647-1 placed in receiving feature C and receiving feature C′, the switching apparatus 1645 of the PCB assembly 1625 can be in one (e.g., a first) configuration. When a jumper 1647 is not inserted into receiving feature C and receiving feature C′, the electrical flow from the connector portion 1635-1 to the main segment of the electrical conductor 1640-3 goes straight to the connector portion 1635-2 of the PCB assembly 1625 without any of the electrical flow being diverted to any of the legs or branches of the electrical conductor 1640-3.

If a jumper 1647 (e.g., jumper 1647-2) is placed in receiving feature D and receiving feature D′, as shown in FIG. 6, power flow in the main segment of the electrical conductor 1640-4 flows through the jumper 1647-2 and through the legs or branches of the electrical conductor 1640-4 to the light sources 1660. In such a case, with the jumper 1647-2 placed in receiving feature D and receiving feature D′, the switching apparatus 1645 of the PCB assembly 1625 can be part of the configuration that also electrically connects the main branch of the electrical conductor 1640-3 to the legs or branches of the electrical conductor 1640-3. When a jumper 1647 is not inserted into receiving feature D and receiving feature D′, the electrical flow from the connector portion 1635-1 to the main segment of the electrical conductor 1640-4 goes straight to the connector portion 1635-2 of the PCB assembly 1625 without any of the electrical flow being diverted to any of the legs or branches of the electrical conductor 1640-4.

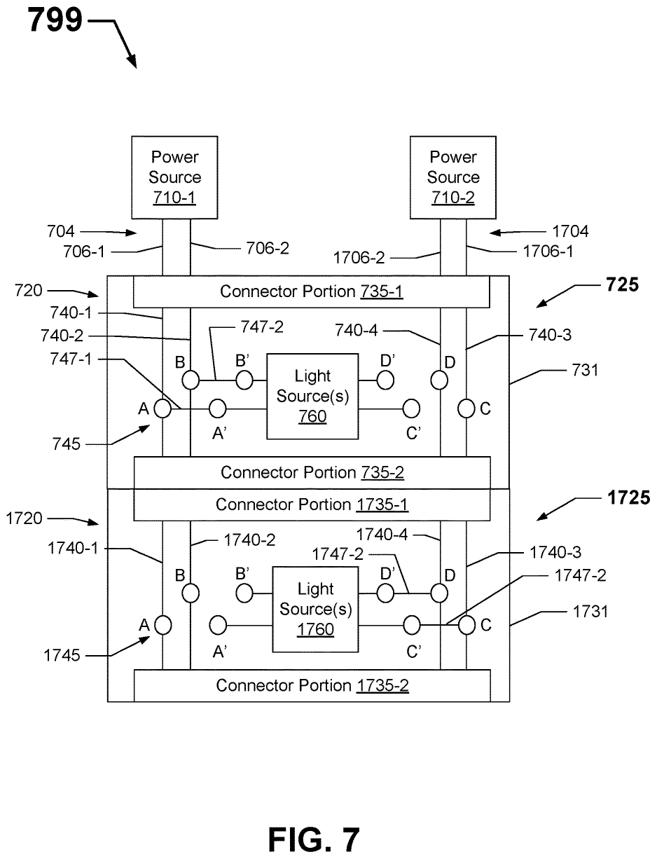

FIG. 7 shows a system diagram of yet another extended light fixture 799 according to certain example embodiments. Referring to FIGS. 1 through 7, the extended light fixture 799 of FIG. 7 is substantially the same as the extended light fixture 699 of FIG. 6 in that the extended light fixture 799 includes two PCB assemblies (PCB assembly 725 and PCB assembly 1725) that are coupled to each other. In this case, the PCB assembly 725 and the PCB assembly 1725 are substantially the same as the PCB assembly 625 and the PCB assembly 1625 of FIG. 6.

More specifically, the body 731 of the PCB 720, connector portion 735-1, connector portion 735-2, the one or more light sources 760, electrical conductor 740-1, electrical conductor 740-2, electrical conductor 740-3, electrical conductor 740-4, receiving feature A, receiving feature A′, receiving feature B, receiving feature B′, receiving feature C, receiving feature C′, receiving feature D, receiving feature D′, switching apparatus 745, jumper 747-1, and jumper 747-2 of the PCB assembly 725 are substantially the same as the corresponding components of the PCB assembly 625 of FIG. 6. Further, the body 1731 of the PCB 1720, connector portion 1735-1, connector portion 1735-2, the one or more light sources 1760, electrical conductor 1740-1, electrical conductor 1740-2, electrical conductor 1740-3, electrical conductor 1740-4, receiving feature A, receiving feature A′, receiving feature B, receiving feature B′, receiving feature C, receiving feature C′, receiving feature D, receiving feature D′, switching apparatus 1745, jumper 1747-1, and jumper 1747-2 of the PCB assembly 1725 are substantially the same as the corresponding components of the PCB assembly 1625 of FIG. 6.

In this case, the extended light fixture 799 of FIG. 7 has two power sources 710 (power source 710-1 and power source 710-2) instead of a single power source, as with the power source 610 of the extended light fixture 699 of FIG. 6. The power sources 710 of FIG. 7 are substantially the same as the power sources discussed above. Power source 710-1 is electrically coupled to the connector portion 1735-1 of the PCB assembly 1725 by two wires 706 (wire 706-1 and wire 706-2) of an electrical cable 704, and power source 710-2 is electrically coupled to the connector portion 1735-1 of the PCB assembly 1725 by two wires 1706 (wire 1706-1 and wire 1706-2) of an electrical cable 1704. The electrical cable 704, the wires 606, the electrical cable 1704, and the wires 1706 are substantially the same as the electrical cables and the wires discussed above.

The electrical flow provided by the power source 710-1 through wire 706-1 and wire 706-2 of the electrical cable 704 flows through the connection portion 735-1 to electrical conductor 740-1 and electrical conductor 740-2, respectively, on the PCB 720 of the PCB assembly 725. Similarly, the electrical flow provided by the power source 710-2 through wire 1706-1 and wire 1706-2 of the electrical cable 1704 flows through the connection portion 735-1 to electrical conductor 740-3 and electrical conductor 740-4, respectively, on the PCB 720 of the PCB assembly 725.

Under the configuration of FIG. 7, by having multiple power sources 710 working in parallel with each other, the length of the extended light fixture 799 and/or the number of PCB assemblies (e.g., PCB assembly 725) and/or the amount of load in the form of light sources (e.g., light sources 760) on one or more of the PCB assemblies can be increased without compromising the performance or reliability of the extended light fixture 799. In some cases, in order to maintain Class 2 requirements (as established by the NEC), each power source 710 can be no greater than 100 W.

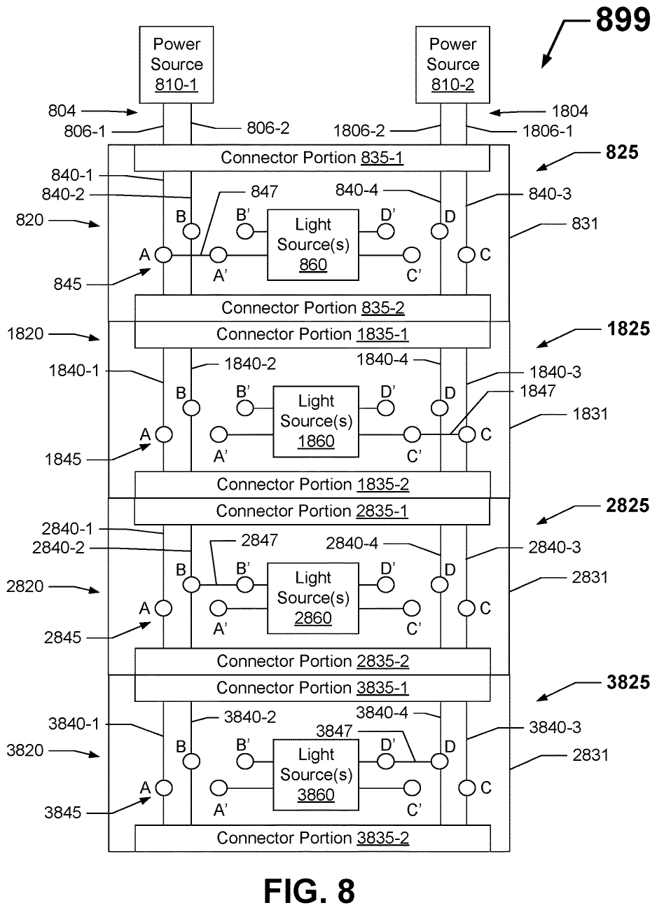

FIG. 8 shows a system diagram of still another extended light fixture 899 according to certain example embodiments. Referring to FIGS. 1 through 8, the extended light fixture 899 of FIG. 8 is substantially the same as the extended light fixture 799 of FIG. 7, except that in this case the extended light fixture has four PCB assemblies (PCB assembly 825, PCB assembly 1825, PCB assembly 2825, and PCB assembly 3825) in series with each other instead of the two PCB assemblies (PCB assembly 725 and PCB assembly 1725) of FIG. 7. In this case, the power source 810-1, the power source 810-2, the electrical cable 804, wire 806-1, wire 806-2, the electrical cable 1804, wire 1806-1, wire 1806-2, the PCB assembly 825, and the PCB assembly 1825 (including their various components) of FIG. 8 are substantially the same as the power source 710-1, the power source 710-2, the electrical cable 704, wire 706-1, wire 706-2, the electrical cable 1704, wire 1706-1, wire 1706-2, the PCB assembly 725, and the PCB assembly 1725 (including their corresponding components) of FIG. 7.

A switching apparatus 845 of the PCB assembly 825 is used to determine which of the legs or branches of an electrical conductor 840 becomes electrically connected to the main segment of that electrical conductor 840. In this example, the switching apparatus 845 is not integrated with the connector portion 835-1. Instead, the switching apparatus 845 in this case includes an electrically-conductive jumper 847 (e.g., a zero-ohm resistor) that is inserted into a subset of the receiving features disposed in the body 831 of the PCB 820. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

In this case, receiving feature A is in electrical communication with the main segment of the electrical conductor 840-1. Receiving feature A′ is in electrical communication with the legs or branches of electrical conductor 840-1 leading to the light sources 860. Receiving feature B is in electrical communication with the main segment of the electrical conductor 840-2. Receiving feature B′ is in electrical communication with the legs or branches of electrical conductor 840-2 leading to the light sources 860. Receiving feature C is in electrical communication with the main segment of the electrical conductor 840-3.

Receiving feature C′ is in electrical communication with the legs or branches of electrical conductor 840-3 leading to the light sources 860. Receiving feature D is in electrical communication with the main segment of the electrical conductor 840-4. Receiving feature D′ is in electrical communication with the legs or branches of electrical conductor 840-4 leading to the light sources 860.

In this case, jumper 847 is placed in receiving feature A and receiving feature A′ to allow power flow in the main segment of the electrical conductor 840-1 to continue through the jumper 847 and through the legs or branches of the electrical conductor 840-1 to the light sources 860. There are no other jumpers in the switching apparatus 845 of the PCB assembly 825, and so the light sources 860 do not receive electrical flow from electrical conductor 840-2, electrical conductor 840-3, or electrical conductor 840-4. Power through the main segments of electrical conductor 840-2, electrical conductor 840-3, and electrical conductor 840-4 flows continually from connector portion 835-1 to connector portion 835-2. The connector portion 835-2 of the PCB assembly 825 is connected to the connector portion 1835-1 of the PCB assembly 1825. In this way, the configuration of the connector portion 835-2 complements the configuration of the connector portion 1835-1. As a result, the main segment of electrical conductor 840-1 is in electrical communication with the main segment of electrical conductor 1840-1 of the PCB 1820 of the PCB assembly 1825, the main segment of electrical conductor 840-2 is in electrical communication with the main segment of electrical conductor 1840-2 of the PCB 1820 of the PCB assembly 1825, the main segment of electrical conductor 840-3 is in electrical communication with the main segment of electrical conductor 1840-3 of the PCB 1820 of the PCB assembly 1825, and the main segment of electrical conductor 840-4 is in electrical communication with the main segment of electrical conductor 1840-4 of the PCB 1820 of the PCB assembly 1825.

A switching apparatus 1845 of the PCB assembly 1825 is used to determine which of the legs or branches of an electrical conductor 1840 becomes electrically connected to the main segment of that electrical conductor 1840. In this example, the switching apparatus 1845 includes an electrically-conductive jumper 1847 (e.g., a zero-ohm resistor) that is inserted into a subset of the receiving features disposed in the body 1831 of the PCB 1820. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

In this case, receiving feature A is in electrical communication with the main segment of the electrical conductor 1840-1. Receiving feature A′ is in electrical communication with the legs or branches of electrical conductor 1840-1 leading to the light sources 1860. Receiving feature B is in electrical communication with the main segment of the electrical conductor 1840-2. Receiving feature B′ is in electrical communication with the legs or branches of electrical conductor 1840-2 leading to the light sources 1860. Receiving feature C is in electrical communication with the main segment of the electrical conductor 1840-3. Receiving feature C′ is in electrical communication with the legs or branches of electrical conductor 1840-3 leading to the light sources 1860. Receiving feature D is in electrical communication with the main segment of the electrical conductor 1840-4.

Receiving feature D′ is in electrical communication with the legs or branches of electrical conductor 1840-4 leading to the light sources 1860.

In this case, jumper 1847 is placed in receiving feature C and receiving feature C′ to allow power flow in the main segment of the electrical conductor 1840-3 to continue through the jumper 1847 and through the legs or branches of the electrical conductor 1840-3 to the light sources 1860. There are no other jumpers in the switching apparatus 1845 of the PCB assembly 1825, and so the light sources 1860 do not receive electrical flow from electrical conductor 1840-1, electrical conductor 1840-2, or electrical conductor 1840-4.

Power through the main segments of electrical conductor 1840-1, electrical conductor 1840-2, and electrical conductor 1840-4 flows continually from connector portion 1835-1 to connector portion 1835-2.

The connector portion 1835-2 of the PCB assembly 1825 is connected to the connector portion 2835-1 of the PCB assembly 2825. In this way, the configuration of the connector portion 1835-2 complements the configuration of the connector portion 2835-1. As a result, the main segment of electrical conductor 1840-1 is in electrical communication with the main segment of electrical conductor 2840-1 of the PCB 2820 of the PCB assembly 2825, the main segment of electrical conductor 1840-2 is in electrical communication with the main segment of electrical conductor 2840-2 of the PCB 2820 of the PCB assembly 2825, the main segment of electrical conductor 1840-3 is in electrical communication with the main segment of electrical conductor 2840-3 of the PCB 2820 of the PCB assembly 2825, and the main segment of electrical conductor 1840-4 is in electrical communication with the main segment of electrical conductor 2840-4 of the PCB 2820 of the PCB assembly 2825.

A switching apparatus 2845 of the PCB assembly 2825 is used to determine which of the legs or branches of an electrical conductor 2840 becomes electrically connected to the main segment of that electrical conductor 2840. In this example, the switching apparatus 2845 is not integrated with the connector portion 2835-1. Instead, the switching apparatus 2845 in this case includes an electrically-conductive jumper 2847 (e.g., a zero-ohm resistor) that is inserted into a subset of the receiving features disposed in the body 2831 of the PCB 2820. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

In this case, receiving feature A is in electrical communication with the main segment of the electrical conductor 2840-1. Receiving feature A′ is in electrical communication with the legs or branches of electrical conductor 2840-1 leading to the light sources 2860. Receiving feature B is in electrical communication with the main segment of the electrical conductor 2840-2. Receiving feature B′ is in electrical communication with the legs or branches of electrical conductor 2840-2 leading to the light sources 2860. Receiving feature C is in electrical communication with the main segment of the electrical conductor 2840-3. Receiving feature C′ is in electrical communication with the legs or branches of electrical conductor 2840-3 leading to the light sources 2860. Receiving feature D is in electrical communication with the main segment of the electrical conductor 2840-4. Receiving feature D′ is in electrical communication with the legs or branches of electrical conductor 2840-4 leading to the light sources 2860.

In this case, jumper 2847 is placed in receiving feature B and receiving feature B′ to allow power flow in the main segment of the electrical conductor 2840-2 to continue through the jumper 2847 and through the legs or branches of the electrical conductor 2840-2 to the light sources 2860. There are no other jumpers in the switching apparatus 2845 of the PCB assembly 2825, and so the light sources 2860 do not receive electrical flow from electrical conductor 2840-1, electrical conductor 2840-3, or electrical conductor 2840-4. Power through the main segments of electrical conductor 2840-1, electrical conductor 2840-3, and electrical conductor 2840-4 flows continually from connector portion 2835-1 to connector portion 2835-2.

The connector portion 2835-2 of the PCB assembly 2825 is connected to the connector portion 3835-1 of the PCB assembly 3825. In this way, the configuration of the connector portion 2835-2 complements the configuration of the connector portion 3835-1. As a result, the main segment of electrical conductor 2840-1 is in electrical communication with the main segment of electrical conductor 3840-1 of the PCB 3820 of the PCB assembly 3825, the main segment of electrical conductor 2840-2 is in electrical communication with the main segment of electrical conductor 3840-2 of the PCB 3820 of the PCB assembly 3825, the main segment of electrical conductor 2840-3 is in electrical communication with the main segment of electrical conductor 3840-3 of the PCB 3820 of the PCB assembly 3825, and the main segment of electrical conductor 2840-4 is in electrical communication with the main segment of electrical conductor 3840-4 of the PCB 3820 of the PCB assembly 3825.

A switching apparatus 3845 of the PCB assembly 3825 is used to determine which of the legs or branches of an electrical conductor 3840 becomes electrically connected to the main segment of that electrical conductor 3840. In this example, the switching apparatus 3845 is not integrated with the connector portion 3835-1. Instead, the switching apparatus 3845 in this case includes an electrically-conductive jumper 3847 (e.g., a zero-ohm resistor) that is inserted into a subset of the receiving features disposed in the body 3831 of the PCB 3820. In this case, there are eight receiving features (receiving feature A, receiving feature A′, receiving feature B, receiving feature B′, receiving feature C, receiving feature C′, and receiving feature D, receiving feature D′), where one subset is made up of receiving feature A and receiving feature A′, a second subset is made up of receiving feature B and receiving feature B′, a third subset is made up of receiving feature C and receiving feature C′, and a fourth subset is made up of receiving feature D and receiving feature D′.

In this case, receiving feature A is in electrical communication with the main segment of the electrical conductor 3840-1. Receiving feature A′ is in electrical communication with the legs or branches of electrical conductor 3840-1 leading to the light sources 3860. Receiving feature B is in electrical communication with the main segment of the electrical conductor 3840-2. Receiving feature B′ is in electrical communication with the legs or branches of electrical conductor 3840-2 leading to the light sources 3860. Receiving feature C is in electrical communication with the main segment of the electrical conductor 3840-3. Receiving feature C′ is in electrical communication with the legs or branches of electrical conductor 3840-3 leading to the light sources 3860. Receiving feature D is in electrical communication with the main segment of the electrical conductor 3840-4.

Receiving feature D′ is in electrical communication with the legs or branches of electrical conductor 3840-4 leading to the light sources 3860.

In this case, jumper 3847 is placed in receiving feature D and receiving feature D′ to allow power flow in the main segment of the electrical conductor 3840-4 to continue through the jumper 3847 and through the legs or branches of the electrical conductor 3840-4 to the light sources 3860. There are no other jumpers in the switching apparatus 3845 of the PCB assembly 3825, and so the light sources 3860 do not receive electrical flow from electrical conductor 3840-1, electrical conductor 3840-2, or electrical conductor 3840-3.

Power through the main segments of electrical conductor 3840-1, electrical conductor 3840-2, and electrical conductor 3840-3 flows continually from connector portion 3835-1 to connector portion 3835-2. The connector portion 3835-2 is not connected to any other component of the extended light fixture 899.

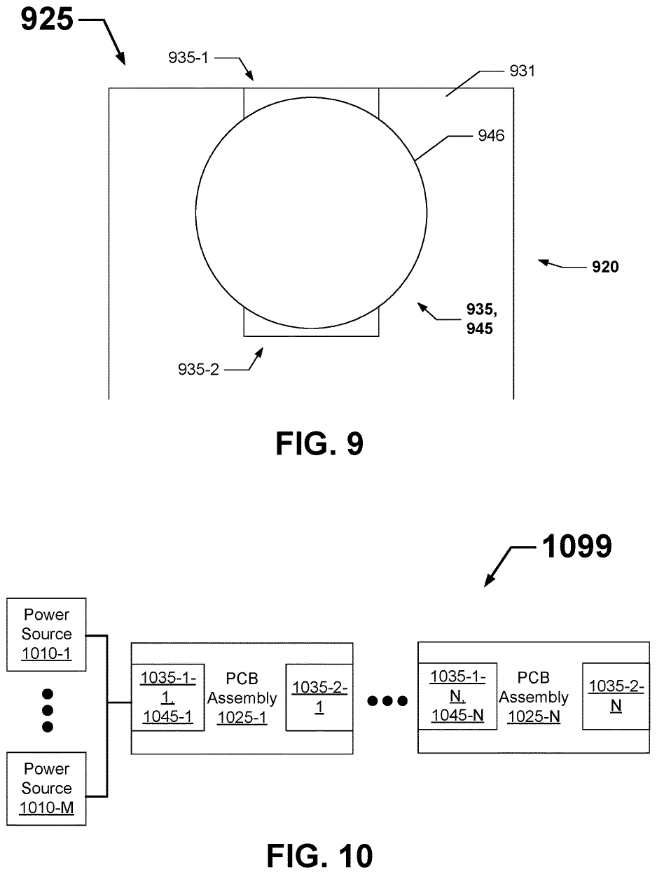

FIG. 9 shows a top view of part of a PCB assembly 925 of an extended light fixture according to certain example embodiments. Referring to FIGS. 1 through 9, the PCB assembly 925 includes a PCB 920 having a body 931, on which is mounted a component of a switching apparatus 945 integrated with two connection portions 935 (connection portion 935-1 and connection portion 935-2). The switching apparatus 945 includes a selector 946 that rotates about an axis perpendicular to the body 931 and the selector 946. Connection portion 935-1 is positioned at one point along an outer perimeter of the selector 946, and connection portion 935-2 is positioned at another point (e.g., opposite where the connection portion 935-1 is positioned) along the outer perimeter of the selector 946.

By rotating the selector 946 to the position shown in FIG. 9, connection portion 935-1 is positioned along the outer perimeter of the body 931 of the PCB 920, making connection portion 935-1 accessible to another component (e.g., one or more wires, the connection portion of another PCB assembly) of the extended light fixture. By rotating the selector 946 approximately 180°from what is shown in FIG. 9, connection portion 935-2 can be positioned along the outer perimeter of the body 931 of the PCB 920, making connection portion 935-2 accessible to another component of the extended light fixture.

Put more generally, the connector portions 935 are movable between a first position and a second position, where one position corresponds to one configuration, and where another position corresponds to another configuration. For example, if the PCB assembly 925 of FIG. 9 also includes one or more light sources (e.g., similar to the light sources 560 above) and two electrical conductors (e.g., similar to electrical conductor 540-1 and electrical conductor 540-2 above), then when the selector 946 of the switching apparatus 945 is in the position shown in FIG. 9, power received by connector portion 935-1 flows through the first electrical conductor to the light sources, while the power flow through the second electrical conductor bypasses the light sources. When the selector 946 of the switching apparatus 945 is rotated by approximately 180°, power received by connector portion 935-2 flows through the second electrical conductor to the light sources, while the power flow through the first electrical conductor bypasses the light sources. The connections that the switching apparatus 945 makes with the electrical conductors can take place at a different layer (e.g., similar to a layer 332) of the PCB 920 relative to what is shown in FIG. 9.

FIG. 10 shows a system diagram of an extended light fixture 1099 according to certain example embodiments. Referring to FIGS. 1 through 10, the extended light fixture 1099 includes one or more power sources 1010 and one or more PCB assemblies 1025. In this case, the extended light fixture 1099 includes M power sources 1010 (power source 1010-1 through power source 1010-M), which are arranged in parallel with each other, and N PCB assemblies 1025 (PCB assembly 1025-1 through PCB assembly 1025-N), which are arranged in series with each other. The number of PCB assemblies 1025 can be the same as, or different than (e.g., more than) the number of power sources 1010.

Each PCB assembly 1025 has a connector portion 1035-1, a connector portion 1035-2, and a switching apparatus 1045, which may or may not be integrated with the connector portion 1035-1. For example, in this case, PCB assembly 1025-1 includes a connector portion 1035-1-1, a connector portion 1035-2-1, and a switching apparatus 1045-1. PCB assembly 1025-N includes a connector portion 1035-1-N, a connector portion 1035-2-N, and a switching apparatus 1045-N. Each PCB of a PCB assembly 1025 also includes multiple electrical conductors (e.g., electrical conductors 440) and one or more light sources (e.g., light sources 860).

Example embodiments can be used to allow for flexible configurations of extended light fixtures (e.g., linear light fixtures). Example embodiments can allow for providing reliable power to all light sources of an extended light fixture using multiple electrical conductors in the PCBs, where the electrical conductors share in serving the light sources along the length of the extended light fixture by configuring one or more switching apparatuses. Example embodiments can be used with extended light fixtures having any of a number of lengths, PCB assemblies, light sources, and/or other features. Example embodiments can be used in new luminaire installations as well as retrofitting existing luminaires. Example embodiments also provide a number of other benefits. Such other benefits can include, but are not limited to, increased ease of maintenance, greater ease of use, increased reliability, modularity, ease of installation, and compliance with industry standards (e.g., Class 2 compliance) that apply to extended light fixtures.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive.

From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. An extended light fixture comprising:
a first power source and second power source;
at least two printed circuit board (PCB) assemblies each comprising:
a PCB comprising a body
a connector portion positioned proximate to an outer perimeter of the body;
a plurality of electrical conductors coupled to the connector portion, wherein each of the plurality of electrical conductors runs continuously along the body from the connector portion;
a switching apparatus in communication with the plurality of electrical conductors, wherein the switching apparatus has a first configuration and a second configuration, wherein the switching apparatus enables a first subset of the plurality of electrical conductors when in the first configuration, and wherein the switching apparatus enables a second subset of the plurality of electrical conductors when in the second configuration; and
a light source-connected to one of the plurality of electrical conductors, wherein the light source operates using electrical flow from the first subset of the plurality of electrical conductors when the switching apparatus is in the first configuration, and wherein the light source is bypassed when the switching apparatus is in the second configuration; and
wherein the first PCB assembly of the at least two PCB assemblies is connected to both the first and second power sources, and the switching apparatus of the first PCB assembly is in the second configuration, wherein the electrical flow from the second power source bypasses the light sources of the first PCB assembly via the second subset of the electrical conductors of the first PCB assembly to the second PCB assembly, wherein the switching apparatus of the second PCB assembly is set to the first configuration wherein the light sources of the second PCB assembly operate using the electrical flow provided from the second power source.

2. The extended light fixture of claim 1, wherein the light sources of both the first PCB assembly and second PCB assembly have a substantially similar electrical demand.

3. The extended light fixture of claim 1, wherein the first or second power source delivers direct current power to the plurality of electrical conductors.

4. The extended light fixture of claim 1, wherein the first or second power source delivers dimming control to the plurality of electrical conductors.

5. The extended light fixture of claim 1, wherein the second power source delivers power to the first subset of the electrical conductors of the first PCB assembly when the first power source is unavailable.

6. The extended light fixture of claim 1, wherein the first or second power source is located remotely from the PCB.

7. The extended light fixture of claim 1, wherein the first and second power source are each capable of providing a maximum amount of power of 100 W.
